(19) United States
(12) Patent Application Publication
(10) Pub. No.: US 2015/0165496 A1
(43) Pub. Date: Jun. 18, 2015

(54) Medical Tube Clearing Systems

(71) Applicant: Phillip M. Moreau, Arlington Heights, IL (US)

(72) Inventor: Phillip M. Moreau, Arlington Heights, IL (US)

(21) Appl. No.: 14/630,835

(22) Filed: Feb. 25, 2015

Related U.S. Application Data
(63) Continuation-in-part of application No. PCT/US2013/057120, filed on Aug. 28, 2013.
(60) Provisional application No. 61/695,209, filed on Aug. 30, 2012.
(60) Provisional application No. 61/710,502, filed on Oct. 5, 2012.

(51) Int. Cl. B08B 9/032

(52) U.S. Cl. CPC B08B 9/0321

(57) ABSTRACT

A system relating to improved medical tube clearing. More particularly, this invention relates to providing a system of tube-clearing devices that utilize “pusher-hydraulic” means in order to clear medical feeding tubes.

### CROSS-REFERENCE TO RELATED APPLICATIONS

This Application is a continuation-in-part of International Application No. PCT/US2013/057120, with an international filing date of 28 Aug. 2013, now pending, claiming priority from U.S. Provisional Application Nos. 61/695,209 with a filing date of 30 Aug. 2012, now expired, and 61/710,502 with a filing date of 5 Oct. 2012, now expired, herein incorporated by reference.

### FEDERALLY SPONSORED RESEARCH OR DEVELOPMENT

N/A

### FIELD OF THE INVENTION

This invention relates to providing a system for improved medical tube clearing. More particularly, this invention relates to providing a system of medical tube-clearing devices that utilize “pusher-hydraulic” means in order to at least clear medically-inserted feeding tubes. Further, this invention relates to providing a system of medical tube-clearing devices to clear surgically-inserted feeding tubes.

Medical feeding tubes are used to provide nutrition to patients who cannot attain nutrition by oral ingestion. Such feeding tubes can become clogged during use. When more than short-term enteral access is needed, gastronomy-(G), jejunostomy-(J) or gastrojejunal-(GJ) tubes may be inserted. Clogging rates of GJ and J-tubes have been reported to be in the range of 25%-35%.

Current standard protocols are to flush the tube after each feeding however, once clogged, tube clearing techniques are at best time consuming and inconsistent. Improvements in the management and unclogging of such feeding tubes would be of great use and benefit to both care givers and individuals utilizing these devices.

A primary object and feature of the present invention is to provide a system overcoming the above-mentioned problem(s).

It is a further object and feature of the present invention to provide such a system including tube-clearing apparatus that preferably utilize “pusher-hydraulic” means in order to clear surgically inserted feeding tubes.

It is a further object and feature of the present invention to provide such a system relating to unblocking at least one medical feeding tube, having at least one blockage, while such medical feeding tube is inserted into at least one human cavity relating to unblocking at least one medical feeding tube, having at least one blockage, while such medical feeding tube is inserted into at least one human cavity.

It is a further object and feature of the present invention to provide such a system comprising a feeding tube clearing kit comprising: a fluid-flow blocker and at least one fluid conduit, having a luer-coupling to couple to a syringe and insertable within a blocked medical feeding tube, to provide pressured fluid into the fluid conduit to the enclosing peripheral wall between the blockage and such fluid-flow blocker.

It is a further object and feature of the present invention to provide at least one method of use of a tube-clearing apparatus that preferably utilize “pusher-hydraulic” means in order to clear medical feeding tubes.

A further primary object and feature of the present invention is to provide such a system that is efficient, inexpensive, and useful. Other objects and features of this invention will become apparent with reference to the following descriptions.

### SUMMARY OF THE INVENTION

In accordance with a preferred embodiment hereof, this invention provides a system, relating to unblocking at least one medical feeding tube, having at least one blockage, while such medical feeding tube is inserted into at least one human cavity, such medical feeding tube having at least one proximal entry opening and at least one distal exit opening and at least one interior lumen extending there between, comprising: at least one fluid-conducting conduit structured and arranged to conduct at least one flow of fluid; and at least one proximal-entry engager structured and arranged to engage the at least one proximal entry opening; wherein such at least one fluid-conducting conduit is configured to be insertable within the at least one blocked medical feeding tube; wherein such at least one proximal-entry engager comprises at least one fluid-flow blocker structured and arranged to block an outward flow of the fluid, through the at least one proximal entry opening, from the at least one interior lumen; wherein such at least one fluid-flow blocker comprises at least one conduit passage structured and arranged to pass at least one portion of such at least one fluid-conducting conduit, through such and the at least one proximal entry opening, to at least one position within the at least one interior lumen; wherein fluid pressure within the at least one interior lumen may be increased, between such at least one fluid-flow blocker and the at least one blockage, by conduction of the at least one flow of fluid through such at least one fluid-conducting conduit; and wherein such increase in fluid pressure assists unblocking the at least one medical feeding tube by exerting at least one fluid force on the at least one blockage to move the at least one blockage outwardly from the at least one distal end.

Moreover, it provides such a system wherein such at least one fluid-conducting conduit comprises at least one coupler structured and arranged to couple such fluid-conducting conduit to at least one fluid-pressure provider structured and arranged to inject at least one fluid into such at least one fluid-conducting conduit. Additionally, it provides such a system wherein such at least one fluid-flow blocker comprises at least one conically-shaped plug structured and arranged to assist pressure sealing of such at least one fluid-flow blocker when engaged within the at least one proximal entry opening. Also, it provides such a system wherein such at least one conically-shaped plug comprises at least one medical-grade plastic. In addition, it provides such a system wherein such at least one fluid-pressure provider comprises at least one syringe. And, it provides such a system wherein such at least one coupler comprises at least one medical-grade luer-lock coupler structured and arranged to couple to at least one compatible luer-lock-coupler device.

Further, it provides such a system wherein such at least one fluid-pressure provider comprises at least one medical-grade fluid injector structured and arranged to inject at least one medical-grade fluid into such at least one fluid-conducting conduit. Even further, it provides such a system wherein such at least one medical-grade fluid comprises medical-grade saline. Moreover, it provides such a system wherein such at least one medical-grade fluid comprises at least one medical-grade enzyme.

Additionally, it provides such a system wherein such at least one fluid-flow blocker comprises at least one rigid plug structured and arranged to resist, when engaged within the at least one proximal entry opening, more fluid pressure than the at least one blockage. Also, it provides such a system wherein such at least one rigid plug comprises at least one friction-enhancer structured and arranged to assist increasing friction between such at least one rigid plug and the at least one proximal entry opening into which such at least one rigid plug is engaged.

In addition, it provides such a system wherein: such fluid-conducting conduit comprises at least one length; and such at least one rigid plug is adjustably positionable along such length. And, it provides such a system wherein such at least one rigid plug and such fluid-conducting conduit are integrally formed as a single unit. Further, it provides such a system further comprising at least one second fluid-flow blocker structured and arranged to block movement from at least one second at least one proximal entry opening.

In accordance with another preferred embodiment hereof, this invention provides a method, relating to unblocking at least one medical feeding tube, having at least one blockage, while such medical feeding tube is inserted into at least one human cavity, such medical feeding tube having at least one proximal entry opening and at least one distal exit opening and at least one interior lumen extending there between, comprising the steps of: providing at least one fluid-conducting conduit comprising at least one proximal-entry engager structured and arranged to engage the at least one proximal entry opening; wherein such at least one proximal-entry engager comprises at least one fluid-flow blocker structured and arranged to block a discharge of fluids, from within the at least one interior lumen, outwardly through the at least one proximal entry, and at least one fluid-pressure provider structured and arranged to generate fluid pressure within the at least one fluid-conducting conduit; inserting such at least one fluid conduit within the at least one interior lumen of the at least one blocked medical feeding tube; using such at least one fluid-flow blocker to form at least one pressurizable interior portion, within the at least one interior lumen, between the at least one blockage and the at least one proximal entry opening, by blocking the discharge of fluids through the at least one proximal entry opening; coupling such at least one fluid-pressure provider to such at least one fluid conduit; pressurizing such interior portion of the at least one interior lumen, between such at least one fluid-flow blocker and the at least one blockage, by conducting at least one flow of fluid through such at least one fluid-conducting conduit; and wherein such fluid-pressure increase assists unblocking the at least one medical feeding tube by moving the at least one blockage outwardly from the at least one distal end.

Even further, it provides such a method further comprising the step of removing such at least one fluid-conducting conduit from the at least one blocked medical feeding tube. Even further, it provides such a method further comprising the step of configuring such at least one fluid-conducting conduit to utilize at least one at least one syringe as such fluid-pressure provider.

In accordance with another preferred embodiment hereof, this invention provides a system, relating to unblocking at least one medical feeding tube, having at least one blockage, while such medical feeding tube is inserted into at least one human cavity, such medical feeding tube having at least one proximal entry opening and at least one distal exit opening and at least one enclosing peripheral wall extending there between, comprising: fluid-flow blocker means for blocking movement from the at least one distal end outwardly across the at least one proximal entry opening; and fluid injector means for injecting fluid within the at least one enclosing peripheral wall between the at least one blockage and such fluid-flow blocker means; wherein fluid pressure may be increased between such fluid-flow blocker means and the at least one blockage; and wherein such fluid pressure increase assists unblocking the at least one medical feeding tube by moving the at least one blockage outwardly from the at least one distal end. Even further, it provides such a system wherein such fluid injector means comprises: fluid conduit means for providing a fluid conduit insertable within the at least one blocked feeding tube; wherein such fluid-flow blocker means comprises passage means for providing passage of such fluid conduit means through such fluid-flow blocker means to provide a passageway from the at least one enclosing peripheral wall between the at least one blockage and such fluid-flow blocker means. Even further, it provides such a system wherein such fluid injector means comprises fluid coupler means for coupling to at least one fluid-pressure provider.

In accordance with another preferred embodiment hereof, this invention provides a kit system, relating to unblocking at least one medical feeding tube, having at least one blockage, while such medical feeding tube is inserted into at least one human cavity, such medical feeding tube having at least one proximal entry opening and at least one distal exit opening and at least one interior lumen extending there between, comprising: at least one medical tube-clearing apparatus; at least one set of instructions instructing the use of such at least one medical tube-clearing apparatus in the unblocking of the at least one medical feeding tube; and at least one package to enclose such at least one medical tube-clearing apparatus and such at least one set of instructions; wherein such at least one medical tube-clearing apparatus comprises; at least one fluid-conducting conduit structured and arranged to conduct at least one flow of fluid, and at least one proximal-entry engager structured and arranged to engage the at least one proximal entry opening; wherein such at least one fluid-conducting conduit is configured to be insertable within the at least one blocked medical feeding tube; wherein such at least one proximal-entry engager comprises at least one fluid-flow blocker structured and arranged to block an outward flow of the fluid, through the at least one proximal entry opening, from the at least one interior lumen; wherein such at least one fluid-flow blocker comprises at least one conduit passage structured and arranged to pass at least one portion of such at least one fluid-conducting conduit, through such and the at least one proximal entry opening, to at least one position within the at least one interior lumen; wherein fluid pressure within the at least one interior lumen may be increased, between such at least one fluid-flow blocker and the at least one blockage, by conduction of the at least one flow of fluid through such at least one fluid-conducting conduit; and wherein such increase in fluid pressure assists unblocking the at least one medical feeding tube by exerting at least one fluid force on the at least one blockage to move the at least one blockage outwardly from the at least one distal end. Even further, it provides such a kit system further comprising at least one second fluid-flow blocker structured and arranged to block movement from at least one second at least one proximal entry opening.

Even further, it provides such a kit system further comprising at least one fluid-pressure provider structured and arranged to inject, under fluid pressure, at least one fluid into such at least one fluid-conducting conduit. Even further, it provides such a kit system wherein such at least one fluid-pressure provider comprises at least one syringe. Even further, it provides such a kit system wherein such at least one fluid-conducting conduit comprises at least one luer-lock coupler.

In accordance with preferred embodiments of the present invention, this invention provides each and every novel feature, element, combination, step and/or method disclosed or suggested by this patent application.

### BRIEF DESCRIPTION OF THE DRAWINGS

To understand the present invention, it will now be described by way of example, with reference to the accompanying drawings and attachments in which:

FIG. 1 shows a perspective view illustrating a medically-inserted feeding tube with inserted medical tube-clearing device of the medical tube clearing systems, according to a preferred embodiment of the present invention.

FIG. 2 shows a perspective view, illustrating the medical tube-clearing device of the medical tube clearing systems, according to the preferred embodiment of FIG. 1.

FIG. 3 shows a detail view of Detail 3-3 of FIG. 1, according to the preferred embodiment of FIG. 1.

FIG. 4 shows a sectional view through the section 4-4 of FIG. 2, according to the preferred embodiment of FIG. 1.

FIG. 5 shows a perspective view, illustrating the medical tube-clearing device with a single plug portion of the medical tube clearing systems, according to another preferred embodiment of the present invention.

FIG. 6 shows a flow diagram showing a preferred method of use of the medical tube-clearing device of the medical tube clearing systems, according to another preferred embodiment of the present invention.

FIG. 7 shows a medical tube-clearing device kit of the medical tube clearing systems, according to a preferred embodiment of the present invention.

FIG. 8 shows a perspective view of a medical tube-clearing device according to an embodiment of the present invention.

FIG. 9 shows a perspective view a plug according to an embodiment of the present invention.

FIG. 10 shows a perspective view of a feeding tube port according to an embodiment of the present invention.

### DETAILED DESCRIPTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

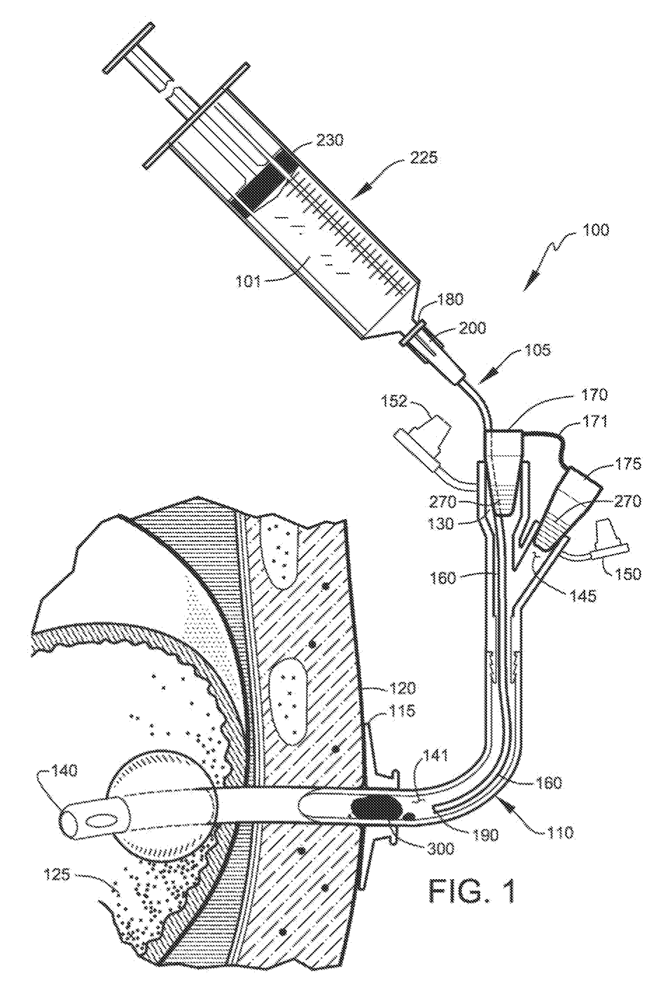

FIG. 1 shows a perspective view illustrating a medically-inserted feeding tube 110 with inserted medical tube-clearing device 105 of the medical tube clearing systems 100, according to a preferred embodiment of the present invention.

Medical tube clearing system 100 preferably comprises medical-tube clearing device 105 preferably designed to assist in clearing surgically inserted feeding tubes. Feeding tube 110 is illustrated as a gastrostomy (G-tube) surgically placed through a stoma 115 through the outer skin 120 into and the stomach 125, as shown.

Upon reading this specification, those with ordinary skill in the art will now appreciate that, under appropriate circumstances, considering such issues as design preference, user preferences, marketing preferences, cost, structural requirements, available materials, technological advances, etc., other medical tube arrangements such as, for example, jejunostomy-tubes (J), gastrojejunal-tubes, foley catheters, other medical catheters, etc., may suffice.

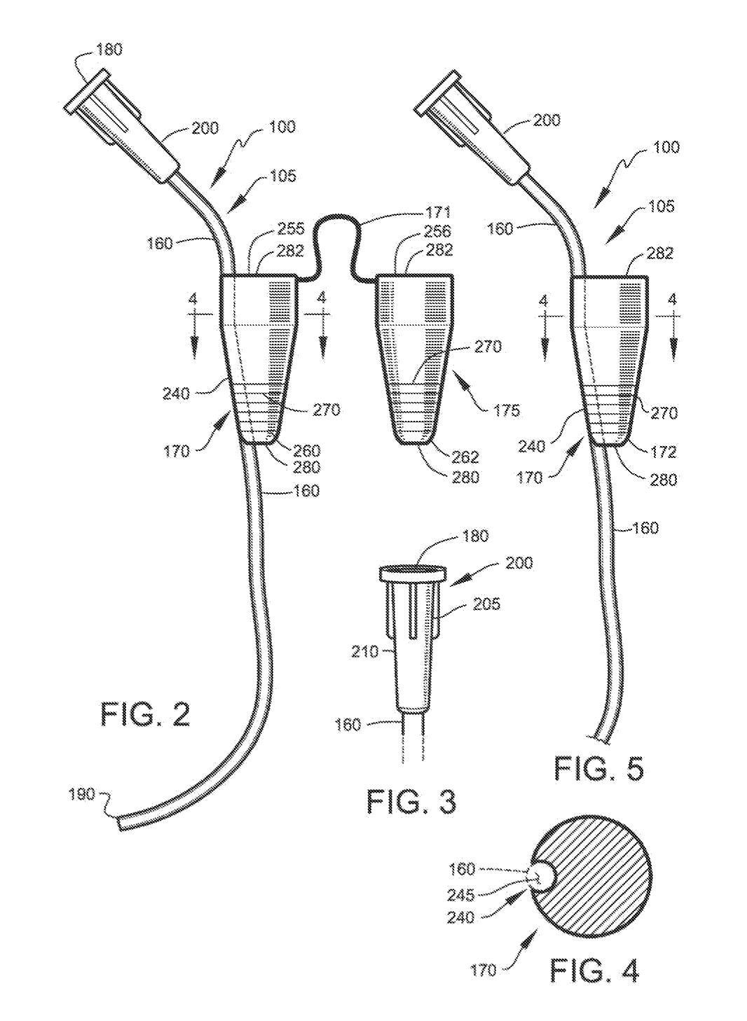

FIG. 2 shows a perspective view, illustrating the medical tube-clearing device 105 of the medical tube clearing systems 100, according to the preferred embodiment of FIG. 1. FIG. 3 shows a detail view of Detail 3-3 of FIG. 1, according to the preferred embodiment of FIG. 1.

Feeding tube 110 preferably comprises at least one first proximal opening 130, at least one distal opening 140, and a continuous internal lumen 141 extending there between, as shown. Feeding tube 110 may also comprise at least one second proximal opening 145, as shown. Preferably, first proximal opening 130 and second proximal opening 145 comprise covers 150 and 152 preferably to cover and seal each respective opening from matter entering the feeding tube 110 through such openings when covered, as shown.

Feeding tube nutrients are preferably delivered through first proximal opening 130 with medicines or additional fluids (saline, enzymes, etc.) preferably delivered through second proximal opening 145. Alternately preferably, nutrients and/or medicines may be delivered through either proximal opening. Upon reading this specification, those with ordinary skill in the art will now appreciate that, under appropriate circumstances, considering such issues as design preference, user preferences, marketing preferences, cost, structural requirements, available materials, technological advances, etc., other feeding tube arrangements such as, for example, having more than two proximal openings, other feeding tube/catheter openings/exits, etc., may suffice.

Medical-tube clearing device 105 preferably comprises at least one fluid-conducting conduit 160 and at least one plug portion 170, preferably two plug portions, plug portion 170 and plug portion 175 (second plug portion), as shown. Plug portion 170 and plug portion 175 are preferably configured to engage, respectively, first proximal opening 130 and second proximal opening 145 (at least embodying herein at least one proximal-entry engager). Preferably, plug portion 170 and plug portion 175 are joined by a lanyard-type connector 171, as shown.

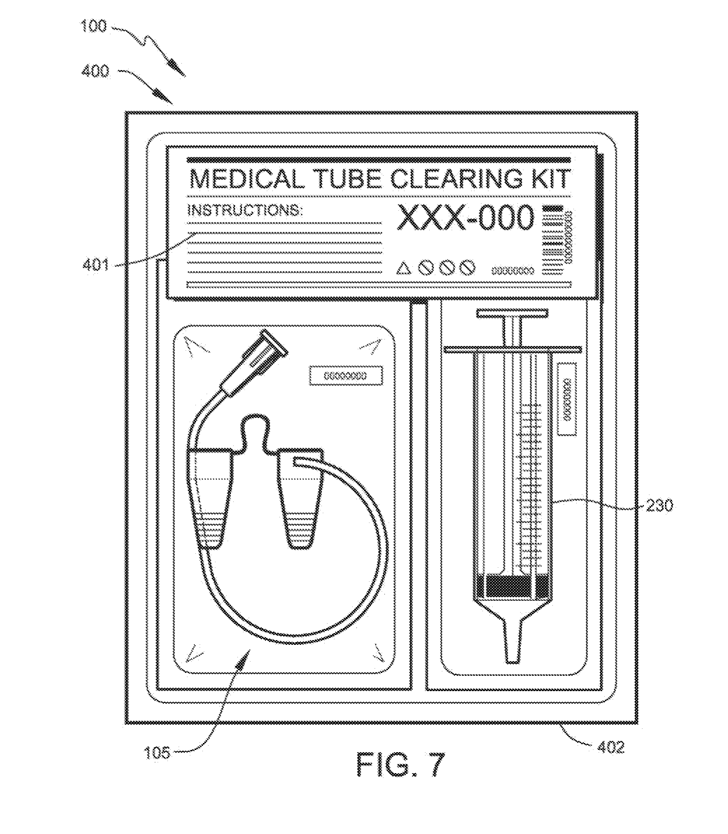

Medical tube-clearing device 105 is preferably supplied as a single use kit comprising at least one medically-acceptable-sealed kit having all the necessary parts as shown in a single container, preferably providing at least one medically sanitary device (See FIG. 7). Upon reading this specification, those with ordinary skill in the art will now appreciate that, under appropriate circumstances, considering such issues as design preference, user preferences, marketing preferences, cost, structural requirements, available materials, technological advances, etc., other medical-tube clearing device packaging arrangements such as, for example, more than one packaged portion, non-medically sealed packaging, soft packaging, hard packaging, sterilizable devices for re-use, etc., may suffice.

Fluid-conducting conduit 160 (at least embodying herein at least one fluid-conducting conduit; and, at least embodying herein fluid conduit means for providing a fluid conduit insertable within the at least one blocked feeding tube) preferably comprises a proximal opening 180 and a distal exit 190, as shown. Fluid-conducting conduit 160 preferably comprises at least one port 200 preferably situate at proximal opening 180, as shown.

Additionally, port 200 preferably comprises coupler 205 (at least embodying herein at least one coupler structured and arranged to couple to at least one fluid-pressure provider structured and arranged to inject at least one fluid into said at least one fluid conduit; and, at least embodying herein wherein said fluid injector means comprises fluid coupler means for coupling to at least one fluid-pressure provider) preferably comprising at least one luer-lock coupling 210 (at least embodying herein wherein said at least one coupler comprises at least one medical-grade luer-lock coupler structured and arranged to couple to at least one compatible luer-lock-coupler device), preferably a medical grade luer-lock coupling preferably providing coupling to at least one fluid-pressure providing device 225, preferably at least one syringe device 230 (at least embodying herein wherein said at least one fluid-pressure provider comprises at least one medical-grade fluid injector structured and arranged to inject at least one medical-grade fluid into said at least one fluid conduit), as shown. Port 200 preferably comprises plastic, preferably rigid plastic. Port 200 preferably is coupled to fluid-conducting conduit 160, preferably a semi-rigid tube of approximately 5 Fr (French size) and preferably of about 15.5 centimeters (cm) length in total length, as shown.

FIG. 4 shows a sectional view through the section 4-4 of FIG. 2, according to the preferred embodiment of FIG. 1. Plug portion 170 preferably comprises at least one passageway 240, preferably comprising a single slot 245 through which fluid-conducting conduit 160 may be inserted so as to assist forming a tight seal when placed into a feeding tube 110, as shown (this arrangement at least embodies herein wherein such at least one fluid-flow blocker comprises at least one conduit passage structured and arranged to pass at least one portion of such at least one fluid-conducting conduit, through such and the at least one proximal entry opening, to at least one position within the at least one interior lumen; and, wherein such at least one fluid-flow blocker comprises at least one conduit passage structured and arranged to pass at least one portion of such at least one fluid-conducting conduit, through such and the at least one proximal entry opening, to at least one position within the at least one interior lumen; and, at least embodying herein wherein said fluid-flow blocker means comprises passage means for providing passage of said fluid conduit means through said fluid-flow blocker means to provide a passageway from the at least one enclosing peripheral wall between the at least one blockage and said fluid-flow blocker means). Passageway 240 is shown along the side of plug portion 170 for preferred ease of manufacturing, however, upon reading this specification, those with ordinary skill in the art will now appreciate that, under appropriate circumstances, considering such issues as design preference, user preferences, marketing preferences, cost, structural requirements, available materials, technological advances, etc., other passageway arrangements such as, for example, through the center, offset placement, etc., may suffice.

Referring again to FIG. 2, plug portion 170 preferably comprises a tapered solid plug 172 (at least embodying herein wherein said at least one fluid-flow blocker comprises at least one conically-shaped plug structured and arranged to assist pressure sealing of the at least one proximal entry opening when placed into such at least one proximal entry opening), preferably constructed of heavy plastic, preferably medical-grade plastic (i.e. approved for medical use), which preferably measures about 3.5 cm long, about 4.2 cm in diameter at the top 255, and tapers to about 2.5 cm diameter at the bottom 260, as shown (the above-described arrangement at least embodies herein wherein said at least one conically-shaped plug comprises at least one medical-grade plastic). Plug portion 170 preferably comprises raised ridges 270 spaced about 5 cm apart and preferably comprising a blunt frustoconical distal end 280 and proximal end 282, as shown.

Plug portion 170 preferably is situate about 9 cm (centimeters) below port 200 extending to about 12.5 cm below port 200, as shown. The most distal part of medical-tube clearing device 105 is preferably the continuation of fluid-conducting conduit 160 and preferably measures about 3.5 cm in length. Upon reading this specification, those with ordinary skill in the art will now appreciate that, under appropriate circumstances, considering such issues as design preference, user preferences, marketing preferences, cost, structural requirements, available materials, technological advances, etc., other plug portion to fluid conduit dimensional arrangements such as, for example, more or less dimensional distances of plug portion to port, more or less extension of fluid conduit distal of plug portion, etc., may suffice.

Plug portion 175 preferably also comprises a tapered solid plug 172, preferably constructed of heavy plastic, which preferably measures about 3.5 cm long, about 4.2 cm in diameter at the top 256, and tapers to about 2.5 cm diameter at the bottom 262, as shown. Plug portion 175 preferably comprises raised ridges 270 spaced about 5 cm apart and preferably comprises closed blunt ends distal end 280 and proximal end 282, as shown. Plug portion 175 preferably omits fluid-conducting conduit 160 passing through passageway 240, as shown. Raised ridges 270 (at least embodying herein wherein said at least one rigid plug comprises at least one friction-enhancer structured and arranged to assist increasing friction between such at least one rigid plug and the at least one proximal entry opening into which such at least one rigid plug is engaged) preferably assist a strong friction fit of plug portion 175 when placed into proximal opening 130 of feeding tube 110, preferably such friction fit being stronger than the hydraulic pressure placed into the feeding tube 110 by fluid-pressure providing device 225, preferably at least one syringe device 230, as it hydraulically pushes fluid 101 into feeding tube 110 to remove blockage 300, as shown. This arrangement at least embodies herein wherein said at least one fluid-flow blocker comprises at least one rigid plug structured and arranged to resist more fluid pressure than the at least one blockage.

As previously indicated, plug portion 175 preferably does not comprise a passageway and is used primarily to engage second proximal opening 145 to block fluid passage (as a plug), when needed. Upon reading this specification, those with ordinary skill in the art will now appreciate that, under appropriate circumstances, considering such issues as design preference, user preferences, marketing preferences, cost, structural requirements, available materials, technological advances, etc., other plug portion arrangements such as, for example, other plug arrangements, utilizing at least one secondary plug portion with a passageway, etc., may suffice.

Preferably, the components of medical-tube clearing device 105 are manufactured and assembled so as to be a one-piece integral device preferably for use as at least a hospital-grade/medical-grade device; for example, being manufactured using materials meeting the necessary medical/biological requirements for use to clear at least feeding tubes for humans; alternately preferably, for medical/biological use in any vertebrate animal feeding tube. Alternately preferably, plug portion 170 and fluid-conducting conduit 160 are formed as separate units preferably allowing plug portion 170 to be adjustably positionable along the length of fluid-conducting conduit 160. Upon reading this specification, those with ordinary skill in the art will now appreciate that, under appropriate circumstances, considering such issues as design preference, user preferences, marketing preferences, cost, structural requirements, available materials, technological advances, etc., other plug portion positioning arrangements such as, for example, semi-permanent attachment, slidable attachment, mechanically fasted attachment, adhesive attachment, laser-stitched attachment, etc., may suffice.

The principal of medical-tube clearing device 105 is to utilize fluid hydraulic pressure in order to clear at least one blockage 300 from at least surgically inserted medical feeding tubes—e.g., Foley catheters that act as a feeding G/J tube or proper G/J tubes. Fluid pressure within the interior lumen 141 may be increased, between the solid plug or plugs (at least embodying herein at least one fluid-flow blocker) and the blockage, preferably by pressurized injecting of fluid 101 through fluid-conducting conduit into the interior lumen 141. The resulting increase in fluid pressure assists unblocking the medical feeding tube by exerting at least one fluid force on the blockage to move the blockage outwardly from interior lumen 141 through distal opening 140.

The fluid-pressure providing device 225, preferably a syringe 230, preferably provides fluid pressure by piston action of the syringe 230, resulting in a forceful hydraulic pressure, when applied to the small diameter of fluid-conducting conduit 160, as shown. Preferably such fluid pressure enables the development of a greater level of force, in pounds-per-square inch (psi), to force blockage 300 from the feeding tube. Plug portion 170 preferably functions to prevent outflow of fluid/fluid pressure through the proximal opening of the feeding tube when positive pressure is generated within interior lumen 141 by the inflow of fluid 101 through the proximal opening via fluid-conducting conduit 160 (this arrangement at least embodies herein wherein such at least one proximal-entry engager comprises at least one fluid-flow blocker structured and arranged to block an outward flow of the fluid, through the at least one proximal entry opening, from the at least one interior lumen; and, this arrangement at least embodies herein fluid-flow blocker means for blocking movement from the at least one distal end outwardly across the at least one proximal entry opening). The preferred offset tubing configuration, which is preferably situated on the side of plug 170, allows for increased agitation and flow of liquid to the area of the clog, which in testing was found to assist the breakdown of material clogging the tube.

Furthermore, the preferred configuration of applicant's apparatus preferably utilizes the inherent pliable nature of the feeding tube to create a “bellows effect” that preferably creates fluctuation and titling of the fluid in the feeding tube. This preferably generates a more effective delivery of other agents (such as digestive enzymes, coffee, cola, etc.) which further increases the likelihood of clearing the feeding tube.

An additional solid plug portion 175 is preferably attached to the “working” plug or included with the apparatus that is preferably inserted into the second proximal opening 145 (also identified as the side port, “medication port”, or “clearing port” of the feeding tube). Most G/J tubes comprised this option. This “side port” communicates with the primary feeding portion to the tube which, when pressure is applied while trying to flush the clogged tube, creates a circuit, forcing the liquid to back through and up the side port, thereby preventing any significant pressure to be applied. The second solid plug preferably prevents any back-flow through the medication port.

FIG. 5 shows a perspective view, illustrating the medical tube-clearing device 105 with a single plug portion 170 of the medical tube clearing systems, according to another preferred embodiment of the present invention. Single plug portion 170 provides for the same functions as described above only for use with feeding tubes having only a single proximal opening.

In another alternate preferred embodiment of the present system, a much smaller version of the above-described embodiment is provided as a variant for use with smaller diameter weighted feeding tubes distributed, for example, under the brand name brand named “Dubhoff tube”. Upon reading this specification, those with ordinary skill in the art will now appreciate that, under appropriate circumstances, considering such issues as design preference, user preferences, marketing preferences, cost, structural requirements, available materials, technological advances, etc., other dimensional arrangements such as, for example, larger or smaller diameter devices, etc., may suffice. Additionally, upon reading this specification, those with ordinary skill in the art will now appreciate that, under appropriate circumstances, considering such issues as design preference, user preferences, marketing preferences, cost, structural requirements, available materials, technological advances, etc., other device-controlling arrangements utilizing the teachings of the above system 100 such as, for example, hand pump devices, machine pump devices, machine-controlled devices, etc., may suffice.

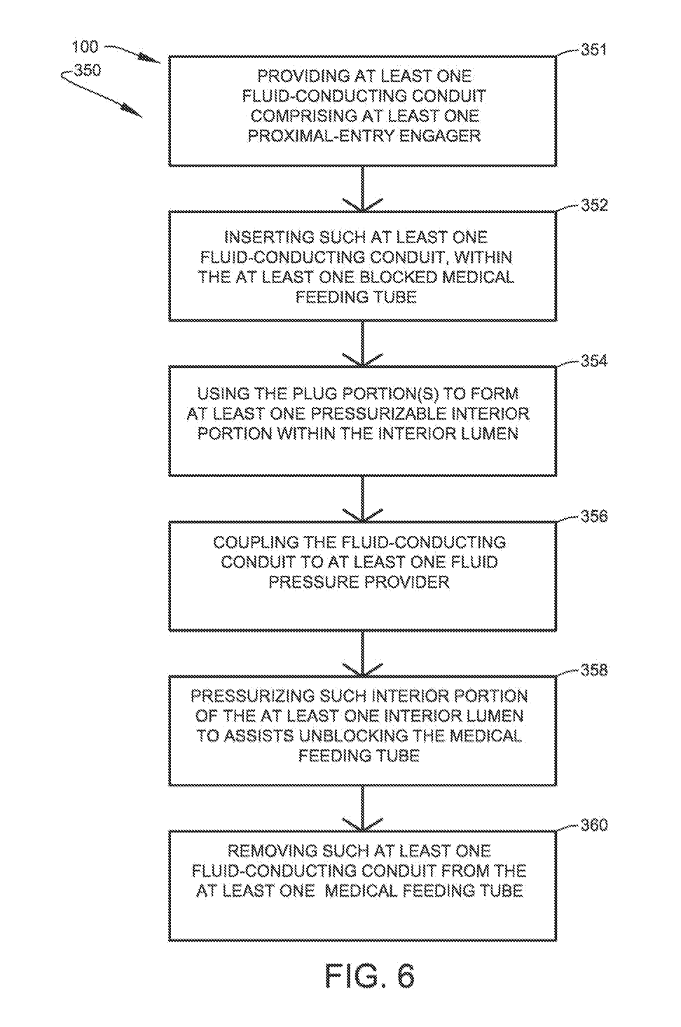

FIG. 6 shows a flow diagram showing a preferred method of use of the medical tube-clearing device 105 of the medical tube clearing systems 100, according to another preferred embodiment of the present invention.

In use, to unblock a medical feeding tube, a user preferably inserts medical-tube clearing device 105 into feeding tube proximal opening 130 preferably extending the distal portion of fluid-conducting conduit 160 until plug portion 170 reaches such proximal opening 130, as shown. Preferably, plug portion 170 is inserted into the feeding tube 110 until outward fluid flow through such proximal opening 130 is blocked. Preferably, raised ridges 270 assist in a tight friction fit of plug portion 170 into the feeding tube proximal opening 130, as shown. When a second feeding tube port is present, second plug portion 175 preferably is then inserted into the (medical port) second proximal opening 145 also until the outward flow of fluids through such opening is blocked, as shown. Next, at least one fluid-pressure providing device 225, preferably a syringe 230, preferably a medical-grade syringe, is coupled to port 200 to provide fluid pressure by injecting fluid 101 through the piston action of the syringe 230 (at least embodying herein fluid injector means for injecting fluid within the at least one enclosing peripheral wall between the at least one blockage and said fluid-flow blocker means, wherein fluid pressure may be increased between said fluid-flow blocker means and the at least one blockage), resulting in a forceful hydraulic pressure inside feeding tube 110. Preferably syringe 230 (at least embodying herein wherein such at least one fluid-pressure provider comprises at least one syringe) is filled with saline fluid 101 or other medically-preferable fluid 101 and used in such manner to flush such feeding tube 110. Preferably, hydraulic pressure from the syringe through the fluid-conducting conduit and into the feeding tube creates a high enough to pressure to flush the blockage 300 through the distal opening 140 of the feeding tube 110, as shown (at least embodying herein wherein such fluid pressure increase assists unblocking the at least one medical feeding tube by moving the at least one blockage outwardly from the at least one distal end). Upon the blockage 300 being flushed, medical-tube clearing device 105 is preferably removed from the feeding tube preferably in reverse order as installed.

The above-described arrangement at least embodies herein preferred method 350 of the present system, relating to hydraulically flushing at least one blocked medical feeding tube while such medical feeding tube is inserted into at least one human cavity, comprising the steps of: Step 351, providing at least one fluid-conducting conduit 160, preferably comprising proximal-entry-engaging plug portion 170 (and alternately preferably, plug portion 175), the plug portion (s) preferably functioning as engageable fluid-flow blockers to block the discharge of fluids, within interior lumen 141, outwardly through the proximal entry or entries of the medical feeding tube; Step 352, inserting at least a portion of such fluid-conducting conduit 160, within interior lumen 141 of the feeding tube; Step 354, using the plug portion (s) to form at least one pressurizable interior portion, within interior lumen 141 (located between blockage 300 and the proximal entry openings), by blocking the outward discharge of fluids through the proximal entry opening(s); Step 356, coupling at least one fluid-pressure provider to fluid-conducting conduit 160; and Step 358, pressurizing such pressurizable interior portion of the at least one interior lumen 141 (located between the plug portions and blockage 300), by injecting fluid 101 through such at least one fluid-conducting conduit 160 into such pressurizable interior portion. The resulting fluid-pressure increase assists unblocking the medical feeding tube by moving the blockage 300 outwardly from the at least one distal end by fluid pressure. In addition, method 350 further comprises Step 360 of removing fluid-conducting conduit 160 from the medical feeding tube.

FIG. 7 shows a medical tube-clearing device kit 400 of the medical tube clearing systems 100, according to a preferred embodiment of the present invention. As stated herein, medical tube-clearing device 105 is preferably supplied as a single use kit 400 comprising at least one medically-acceptable-sealed package 402 having all the necessary parts as shown in a single container, preferably providing at least one medically sanitary device.

Preferably, kit 400 at least comprises: medical at least one medical-tube clearing device 105, at least one set of instructions 401 instructing the use of medical-tube clearing device 105 in unblocking the medical feeding tube, and at least one medically-acceptable-sealed package 402 to enclose medical-tube clearing device 105 and instructions 401. Alternately preferably, Kit 400 contains at least one syringe device 230. Upon reading this specification, those with ordinary skill in the art will now appreciate that, under appropriate circumstances, considering such issues as design preference, user preferences, marketing preferences, cost, structural requirements, available materials, technological advances, etc., other kit arrangements such as, for example, including saline, additional sized fluid conduits, alternately preferable sized plugs, enzymes, etc., may suffice.

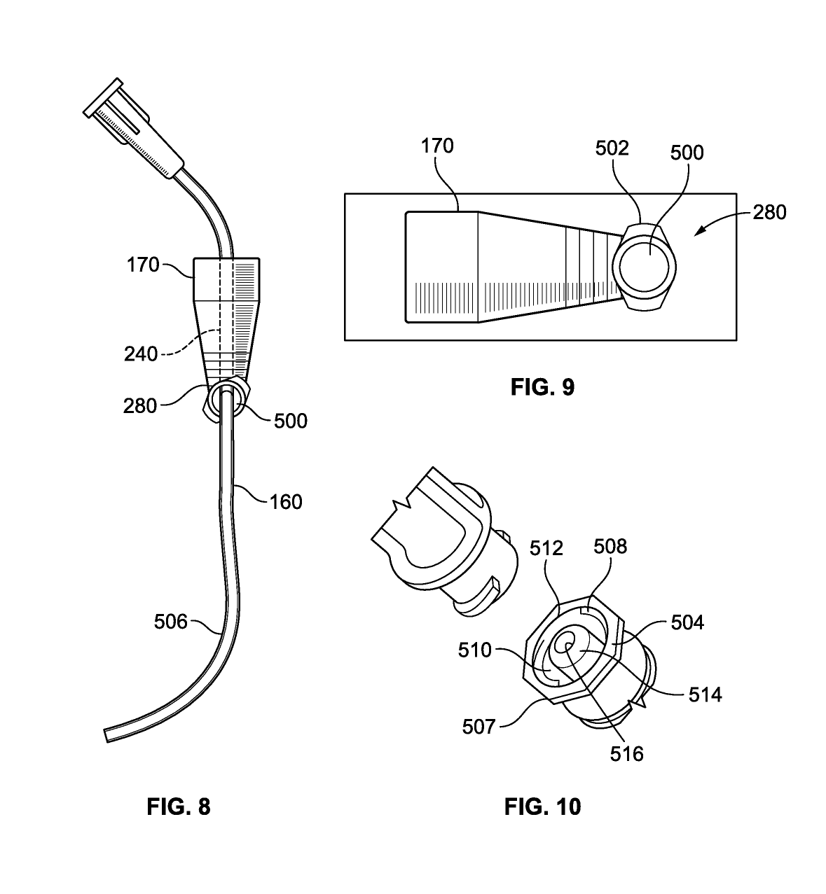

In another embodiment shown in FIGS. 8-10, the passageway 240 is located through the center of the plug portion 170 into which the fluid-conducting conduit 160 is inserted. The passageway 240 terminates in and opening 500 at the distal end 280. The plug portion 170 also includes a pair opposing flanges 502 located at the bottom 262 near the distal end 280.

The flanges 502 cooperate with a feeding tube port 504 integral with a feeding tube 506. The port 504 includes an outer flange 507, a pair of inner flanges 508 located on opposing sides of an orifice 510. Between flanges 508 are opposing spaces 512. The port 504 also includes a cylindrical center portion 514 having a thruway 516 extending to and communicating with the feeding tube 506.

The plug portion 170 is attached to the port 504 by inserting the flanges 502 into the spaces 512, and turning so that the flanges 502 abut the inner flanges 508. The center portion 514 and thruway 516 allow fluid communication between the plug portion 170 and feeding tube 506.

Although applicant has described applicant's preferred embodiments of this invention, it will be understood that the broadest scope of this invention includes modifications such as diverse shapes, sizes, and materials. Such scope is limited only by the below claims as read in connection with the above specification. Further, many other advantages of applicant's invention will be apparent to those skilled in the art from the above descriptions and the below claims.

Many modifications and variations of the present invention are possible in light of the above teachings. It is, therefore, to be understood within the scope of the appended claims the invention may be protected otherwise than as specifically described.

I claim:

1. A system, relating to unblocking at least one medical feeding tube, having at least one blockage, while such medical feeding tube is inserted into at least one human cavity, such medical feeding tube having at least one proximal entry opening and at least one distal exit opening and at least one interior lumen extending there between, comprising:
a) at least one fluid-conducting conduit structured and arranged to conduct at least one flow of fluid;
b) at least one proximal-entry engager structured and arranged to engage the at least one proximal entry opening;
c) wherein said at least one fluid-conducting conduit is configured to be insertable within the at least one blocked medical feeding tube;
d) wherein said at least one proximal-entry engager comprises at least one fluid-flow blocker structured and arranged to block an outward flow of the fluid, through the at least one proximal entry opening, from the at least one interior lumen;
e) wherein said at least one fluid-flow blocker comprises at least one conduit passage structured and arranged to pass at least one portion of said at least one fluid-conducting conduit, through said at least one proximal entry opening, to at least one position within the at least one interior lumen;
f) wherein fluid pressure within the at least one interior lumen may be increased, between said at least one fluid-flow blocker and the at least one blockage, by conduction of the at least one flow of fluid through said at least one fluid-conducting conduit; and
g) wherein such increase in fluid pressure assists unblocking the at least one medical feeding tube by exerting at least one fluid force on the at least one blockage to move the at least one blockage outwardly from the at least one distal end.

2. The system according to claim 1 wherein said at least one fluid-conducting conduit comprises at least one coupler structured and arranged to couple said fluid-conducting conduit to at least one fluid-pressure provider structured and arranged to inject at least one fluid into said at least one fluid-conducting conduit.

3. The system according to claim 1 wherein said at least one fluid-flow blocker comprises at least one conically-shaped plug structured and arranged to assist pressure sealing of said at least one fluid-flow blocker when engaged within the at least one proximal entry opening.

4. The system according to claim 3 wherein said at least one conically-shaped plug comprises at least one medical-grade plastic.

5. The system according to claim 2 wherein such at least one fluid-pressure provider comprises at least one syringe.

6. The system according to claim 2 wherein said at least one coupler comprises at least one medical-grade luer-lock coupler structured and arranged to couple to at least one compatible luer-lock-coupler device.

7. The system according to claim 1 wherein said at least one fluid-pressure provider comprises at least one medical-grade fluid injector structured and arranged to inject at least one medical-grade fluid into said at least one fluid-conducting conduit.

8. The system according to claim 7 wherein such at least one medical-grade fluid comprises medical-grade saline.

9. The system according to claim 7 wherein such at least one medical-grade fluid comprises at least one medical-grade enzyme.

10. The system according to claim 1 wherein said at least one fluid-flow blocker comprises at least one rigid plug structured and arranged to resist, when engaged within the at least one proximal entry opening, more fluid pressure than the at least one blockage.

11. The system according to claim 10 wherein said at least one rigid plug comprises at least one friction-enhancer structured and arranged to assist increasing friction between said at least one rigid plug and the at least one proximal entry opening into which said at least one rigid plug is engaged.

12. The system according to claim 11 wherein:
a) said fluid-conducting conduit comprises at least one length; and
b) said at least one rigid plug is adjustably positionable along such length.

13. The system according to claim 11 wherein said at least one rigid plug and said fluid-conducting conduit are integrally formed as a single unit.

14. The system according to claim 11 further comprising at least one second fluid-flow blocker structured and arranged to block movement from at least one second at least one proximal entry opening.

15. A method, relating to unblocking at least one medical feeding tube, having at least one blockage, while such medical feeding tube is inserted into at least one human cavity, such medical feeding tube having at least one proximal entry opening and at least one distal exit opening and at least one interior lumen extending there between, comprising the steps of:
a) providing at least one fluid-conducting conduit comprising at least one proximal-entry engager structured and arranged to engage the at least one proximal entry opening;
b) wherein such at least one proximal-entry engager comprises at least one fluid-flow blocker structured and arranged to block a discharge of fluids, from within the at least one interior lumen, outwardly through the at least one proximal entry;
c) inserting such at least one fluid-conducting conduit within the at least one interior lumen of the at least one blocked medical feeding tube;
d) using such at least one fluid-flow blocker to form at least one pressurizable interior portion, within the at least one interior lumen, between the at least one blockage and the at least one proximal entry opening, by blocking the discharge of fluids through the at least one proximal entry opening;
e) coupling to such at least one fluid conduit, at least one fluid-pressure provider structured and arranged to generate fluid pressure within the at least one fluid-conducting conduit; and
f) pressurizing such interior portion of the at least one interior lumen, between said at least one fluid-flow blocker and the at least one blockage, by conducting at least one flow of fluid through said at least one fluid-conducting conduit;
g) wherein such fluid-pressure increase assists unblocking the at least one blocked medical feeding tube by moving the at least one blockage outwardly from the at least one distal end.

16. The method according to claim 15 further comprising the step of removing such at least one fluid-conducting conduit from the at least one interior lumen.

17. The method according to claim 15 further comprising the step of configuring such at least one fluid-conducting conduit to utilize at least one at least one syringe as such fluid-pressure provider.

18. A system, relating to unblocking at least one medical feeding tube, having at least one blockage, while such medical feeding tube is inserted into at least one human cavity, such medical feeding tube having at least one proximal entry opening and at least one distal exit opening and at least one enclosing peripheral wall extending there between, comprising:
a) fluid-flow blocker means for blocking movement from the at least one distal end outwardly across the at least one proximal entry opening; and
b) fluid injector means for injecting fluid within the at least one enclosing peripheral wall between the at least one blockage and said fluid-flow blocker means;
c) wherein fluid pressure may be increased between said fluid-flow blocker means and the at least one blockage; and
d) wherein such fluid pressure increase assists unblocking the at least one medical feeding tube by moving the at least one blockage outwardly from the at least one distal end.

19. The system according to claim 18 wherein said fluid injector means comprises:
a) fluid conduit means for providing a fluid conduit insertable within the at least one blocked feeding tube;
b) wherein said fluid-flow blocker means comprises passage means for providing passage of said fluid conduit means through said fluid-flow blocker means to provide a passageway from the at least one enclosing peripheral wall between the at least one blockage and said fluid-flow blocker means.

20. The system according to claim 19 wherein said fluid injector means comprises fluid coupler means for coupling to at least one fluid-pressure provider.

21. A kit system, relating to unblocking at least one medical feeding tube, having at least one blockage, while such medical feeding tube is inserted into at least one human cavity, such medical feeding tube having at least one proximal entry opening and at least one distal exit opening and at least one interior lumen extending there between, comprising:
a) at least one medical-tube clearing apparatus;
b) at least one set of instructions instructing the use of said at least one medical-tube clearing apparatus in the unblocking of the at least one medical feeding tube; and
c) at least one package to enclose said at least one medical-tube clearing apparatus and said at least one set of instructions;
d) wherein said at least one medical-tube clearing apparatus comprises
i) at least one fluid-conducting conduit structured and arranged to conduct at least one flow of fluid, and
ii) at least one proximal-entry engager structured and arranged to engage the at least one proximal entry opening,
iii) wherein said at least one fluid-conducting conduit is configured to be insertable within the at least one blocked medical feeding tube,
iv) wherein said at least one proximal-entry engager comprises at least one fluid-flow blocker structured and arranged to block an outward flow of the fluid, through the at least one proximal entry opening, from the at least one interior lumen,
v) wherein said at least one fluid-flow blocker comprises at least one conduit passage structured and arranged to pass at least one portion of said at least one fluid-conducting conduit, through said and the at least one proximal entry opening, to at least one position within the at least one interior lumen,
vi) wherein fluid pressure within the at least one interior lumen may be increased, between said at least one fluid-flow blocker and the at least one blockage, by conduction of the at least one flow of fluid through said at least one fluid-conducting conduit, and
vii) wherein such increase in fluid pressure assists unblocking the at least one medical feeding tube by exerting at least one fluid force on the at least one blockage to move the at least one blockage outwardly from the at least one distal end.

22. The kit system according to claim 21 further comprising at least one second fluid-flow blocker structured and arranged to block movement from at least one second at least one proximal entry opening.

23. The kit system according to claim 21 further comprising at least one fluid-pressure provider structured and arranged to inject, under fluid pressure, at least one fluid into said at least one fluid-conducting conduit.

24. The kit system according to claim 23 wherein said at least one fluid-pressure provider comprises at least one syringe.

25. The kit system according to claim 21 wherein said at least one fluid-conducting conduit comprises at least one luer-lock coupler.
